(19) United States
(12) Patent Application Publication
(10) Pub. No.: US 2014/0022800 A1
(43) Pub. Date: Jan. 23, 2014

(54) Cup-shaped heat dissipater having heat conductive rib therein and applied in electric luminous body

(71) Applicant: Tai-Her YANG, Dzan-Hwa (TW)

(72) Inventor: Tai-Her YANG, Dzan-Hwa (TW)

(21) Appl. No.: 13/554,110

(22) Filed: Jul. 20, 2012

(51) Int. Cl. F21V 29/00

(52) U.S. Cl. 362/382

(57) ABSTRACT

The present invention utilizes the outer cup bottom of the cup-shaped heat dissipater (100) having heat conductive rib therein being formed as a planar or convex or concave surface for accommodating the electric luminous body (200), and the enlarged heat dissipation surface formed in the cup-shaped inner recessed structure of the heat dissipater (100) opposite to the installation location of the electric luminous body (200) can directly dissipate the heat through the larger heat dissipation area; moreover, with the heat conductive rib structure (310) connecting with the inner periphery of the cup-shaped inner recessed structure of the heat dissipater (100) and the heat source zone having its bottom being installed with the electric luminous body (200), the heat in the central heat source zone can be assisted to be dissipated to the surrounding through the annular surface of heat dissipater (101).

### BACKGROUND OF THE INVENTION

(a) Field of the Invention

The present invention provides a novel cup-shaped heat dissipater having heat conductive rib therein for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater (100), and further with the enlarged heat dissipation surface formed in the cup-shaped inner recessed structure of the heat dissipater (100) opposite to the installation location of the electric luminous body (200), the heat can also be directly dissipated through the larger heat dissipation area; moreover, with the heat conductive rib structure (310) oppositely formed in the cup-shaped inner recessed structure of the heat dissipater (100) and combined with the inner periphery of the cup-shaped inner recessed structure of the heat dissipater (100) and the heat source zone having its bottom being installed with the electric luminous body (200), the heat in the central heat source zone can be assisted to be dissipated to the surrounding through the annular surface of heat dissipater (101).

(b) Description of the Prior Art

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

### SUMMARY OF THE INVENTION

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area; the present invention provides a novel cup-shaped heat dissipater having heat conductive rib therein for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater (100), and further with the enlarged heat dissipation surface formed in the cup-shaped inner recessed structure of the heat dissipater (100) opposite to the installation location of the electric luminous body (200), the heat can also be directly dissipated through the larger heat dissipation area; moreover, with the heat conductive rib structure (310) oppositely formed in the cup-shaped inner recessed structure of the heat dissipater (100) and combined with the inner periphery of the cup-shaped inner recessed structure of the heat dissipater (100) and the heat source zone having its bottom being installed with the electric luminous body (200), the heat in the central heat source zone can be assisted to be dissipated to the surrounding through the annular surface of heat dissipater (101).

### BRIEF DESCRIPTION OF THE DRAWINGS

FIG. 1 is a cross sectional view showing the basic structure of the heat dissipater (100), according to the present invention.

FIG. 2 is a top view of FIG. 1.

FIG. 3 is a cross sectional view illustrating the cup-shaped structure formed in the heat dissipater (100) opposite to the installation location of the electric luminous body (200) being formed with a single annular cup-shaped inner recessed structure, according to the present invention.

FIG. 4 is a top view of FIG. 3.

FIG. 5 is a cross sectional view illustrating the cup-shaped structure formed in the heat dissipater (100) opposite to the installation location of the electric luminous body (200) being formed with a multiple annular cup-shaped inner recessed structure, according to the present invention.

FIG. 6 is a top view of FIG. 5.

FIG. 7 is a cross sectional view of the first embodiment of the present invention illustrating the cup-shaped structure formed in the heat dissipater (100) opposite to the installation location of the electric luminous body (200) being formed with a single annular cup-shaped inner recessed structure and a stepped structure having the higher central column (103) and the lower outer periphery.

FIG. 8 is a top view of FIG. 7.

FIG. 9 is a cross sectional view of the second embodiment of the present invention illustrating the cup-shaped structure formed in the heat dissipater (100) opposite to the installation location of the electric luminous body (200) being formed with a single annular cup-shaped inner recessed structure and a stepped structure having the lower central column (103) and the higher outer periphery.

FIG. 10 is a top view of FIG. 9.

FIG. 11 is a cross sectional view of the third embodiment of the present invention illustrating the cup-shaped structure formed in the heat dissipater (100) opposite to the installation location of the electric luminous body (200) being formed with a multiple annular cup-shaped inner recessed structure and a multiple stepped structure having the higher central column (103) and the lower multiple annular outer periphery.

FIG. 12 is a top view of FIG. 11.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a central column (103) and a heat conductive rib structure (310).

FIG. 14 is a top view of FIG. 13.

FIG. 15 is a schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notches (105) and a structure having the higher central column (103) and the lower outer periphery.

FIG. 16 is a top view of FIG. 15.

FIG. 17 is a schematic view illustrating the heat dissipater (100) opposite to the installation location of the electric luminous body (200) being installed with a conical column member and the cup-shaped structure being formed as a fork-shaped annular structure, according to the present invention.

FIG. 18 is a top view of FIG. 17.

FIG. 19 is a schematic structural view illustrating the central column (103) being composed as a tubular central column, according to one embodiment of the present invention.

FIG. 20 is a schematic lateral view illustrating the top of the heat dissipater (100) opposite to the installation location of the electric luminous body (200) being additionally installed with a protection net (109), according to one embodiment of the present invention.

FIG. 21 is a schematic lateral view illustrating the top of the heat dissipater (100) opposite to the installation location of the electric luminous body (200) being installed with a top cover (110), and formed with a ventilation port (112) and a support column (111) served for combining and supporting between the top cover (110) and the heat dissipater (100), according to one embodiment of the present invention.

FIG. 22 is a schematic lateral view illustrating the support column (111) served for combining and supporting being installed between the top of the heat dissipater (100) opposite to the installation location of the electric luminous body (200) and the top cover (110), and the periphery of the ventilation port (112) being additionally installed with the protection net (109), according to one embodiment of the present invention.

### DESCRIPTION OF MAIN COMPONENT SYMBOLS

100: Heat dissipater
101: Annular surface of heat dissipater
103: Central column
105: Tooth notch
106: Fork-shaped annular structure
109: Protection net
110: Top cover
111: Support column
112: Ventilation port
120: Cup bottom surface
200: Electric luminous body
310: Heat conductive rib structure

### DETAILED DESCRIPTION OF THE PREFERRED EMBODIMENTS

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

The present invention provides a novel cup-shaped heat dissipater having heat conductive rib therein for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater (100), and further with the enlarged heat dissipation surface formed in the cup-shaped inner recessed structure of the heat dissipater (100) opposite to the installation location of the electric luminous body (200), the heat can also be directly dissipated through the larger heat dissipation area; with the heat conductive rib structure (310) oppositely formed in the cup-shaped inner recessed structure of the heat dissipater (100) and combined with the inner periphery of the cup-shaped inner recessed structure of the heat dissipater (100) and the heat source zone having its bottom being installed with the electric luminous body (200), the heat in the central heat source zone can be assisted to be dissipated to the surrounding through the annular surface of heat dissipater (101).

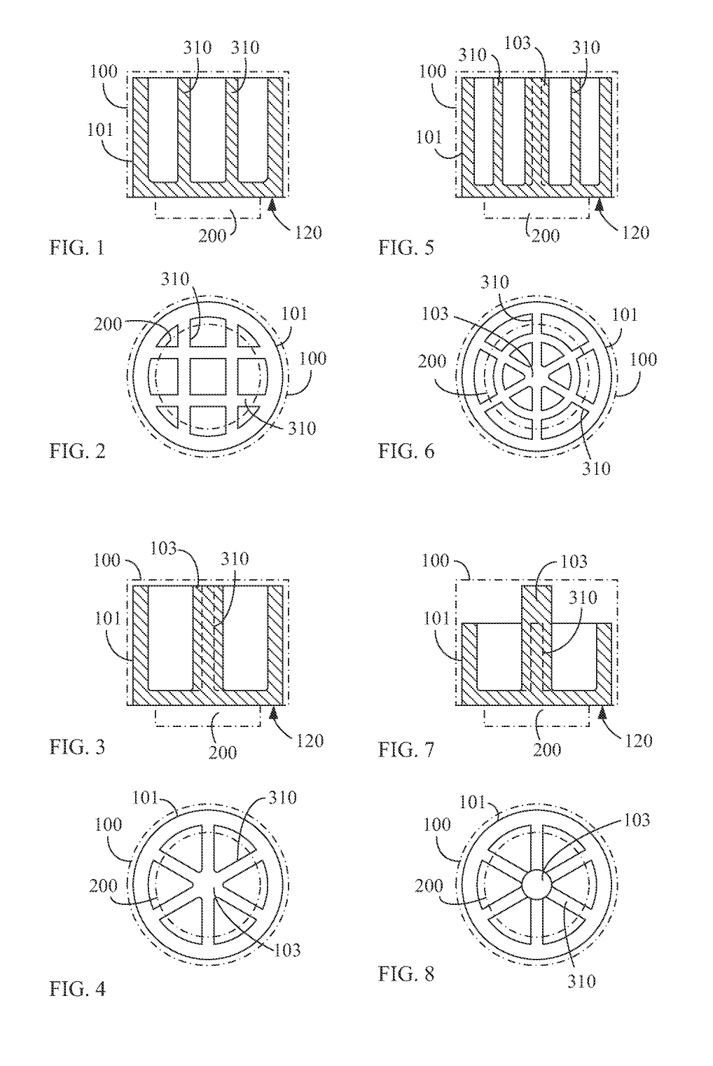

FIG. 1 is a cross sectional view showing the basic structure of the heat dissipater (100), according to the present invention;

FIG. 2 is a top view of FIG. 1;

As shown in FIG. 1 and FIG. 2, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a multiple grid state with circular or polygonal shape having three or more sides (as shown in FIG. 1 is an embodiment formed in a rectangular grid state), disposed in the cup-shaped inner recessed structure, served for connecting between the inner periphery of the cup-shaped inner recessed structure of the heat dissipater (100) and the heat source zone having its bottom being installed with the electric luminous body (200) for transferring the heat;

the outer cup bottom of the cup-shaped heat dissipater is formed as a planar or convex or concave surface for accommodating the electric luminous body (200), so the heat generated by the electric luminous body (200) can be dissipated to the exterior from the surface of the heat dissipater, and further with the enlarged heat dissipation surface formed in the cup-shaped inner recessed structure opposite to the installation location of the electric luminous body (200), the heat can also be directly dissipated through the larger heat dissipation area; moreover, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200), the heat in the central heat source zone can be assisted to be dissipated to the surrounding through the surface of the heat conductive rib (310) and the annular surface of heat dissipater (101).

FIG. 3 is a cross sectional view illustrating the cup-shaped structure formed in the heat dissipater (100) opposite to the installation location of the electric luminous body (200) being formed with a single annular cup-shaped inner recessed structure, according to the present invention;

FIG. 4 is a top view of FIG. 3;

As shown in FIG. 3 and FIG. 4, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), the other surface of the heat dissipater (100) is formed with the single cup-shaped inner recessed structure and a central column (103); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) (as shown in FIG. 3 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100), the central column (103) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

FIG. 5 is a cross sectional view illustrating the cup-shaped structure formed in the heat dissipater (100) opposite to the installation location of the electric luminous body (200) being formed with a multiple annular cup-shaped inner recessed structure, according to the present invention;

FIG. 6 is a top view of FIG. 5;

As shown in FIG. 5 and FIG. 6, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), the other surface of the heat dissipater (100) is formed with two or more cup-shaped inner recessed structures and the central column (103) and two or more layers of annular surfaces of heat dissipater (101); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) (as shown in FIG. 5 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the two or more cup-shaped inner recessed structures formed on the other surface of the heat dissipater (100), the central column (103) and two or more layers of annular surfaces of heat dissipater (101); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the inner annular heat dissipater and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

FIG. 7 is a cross sectional view of the first embodiment of the present invention illustrating the cup-shaped structure formed in the heat dissipater (100) opposite to the installation location of the electric luminous body (200) being formed with a single annular cup-shaped inner recessed structure and a stepped structure having the higher central column (103) and the lower outer periphery;

FIG. 8 is a top view of FIG. 7;

As shown in FIG. 7 and FIG. 8, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single cup-shaped inner recessed structure and a higher central column (103), thereby forming a stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) (as shown in FIG. 7 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100), the higher central column (103) thereby forming a stepped structure having the higher central column (103) and the lower outer periphery and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

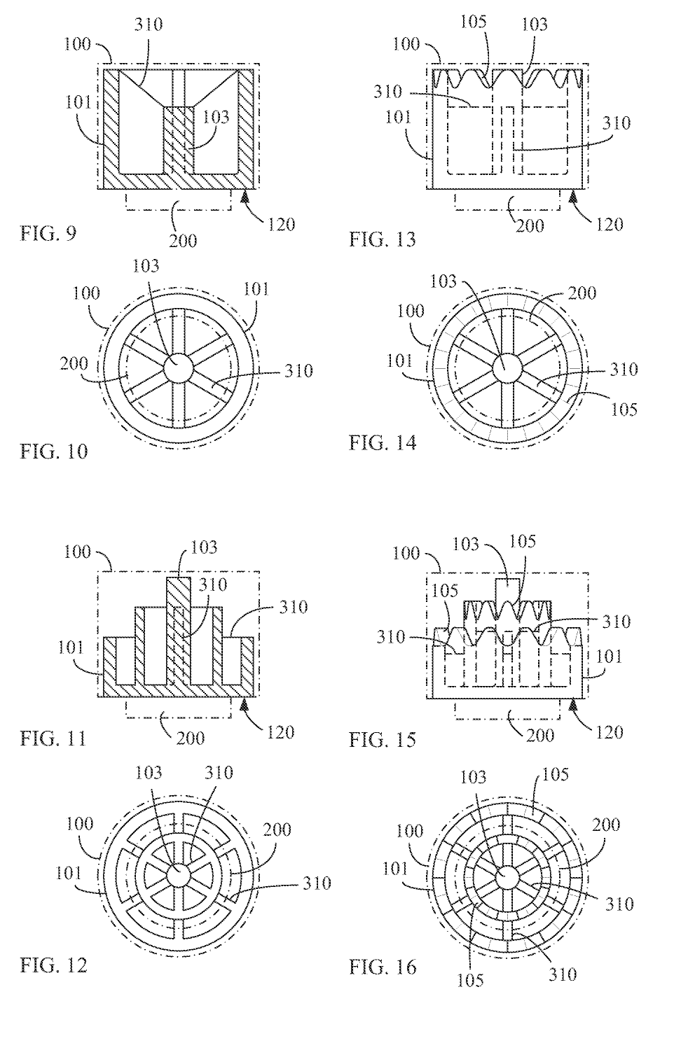

FIG. 9 is a cross sectional view of the second embodiment of the present invention illustrating the cup-shaped structure formed in the heat dissipater (100) opposite to the installation location of the electric luminous body (200) being formed with a single annular cup-shaped inner recessed structure and a stepped structure having the lower central column (103) and the higher outer periphery;

FIG. 10 is a top view of FIG. 9;

As shown in FIG. 9 and FIG. 10, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single cup-shaped inner recessed structure and a lower central column (103), thereby forming a stepped structure having the lower central column (103) and the higher outer periphery; the surface of one or both of the cup periphery and/or the inner annular surface of the heat dissipater (100) is formed as a planar or wavelike structure or formed with a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) (as shown in FIG. 9 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100) and the lower central column (103), thereby forming a stepped structure having the lower central column (103) and the higher outer periphery and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

FIG. 11 is a cross sectional view of the third embodiment of the present invention illustrating the cup-shaped structure formed in the heat dissipater (100) opposite to the installation location of the electric luminous body (200) being formed with a multiple annular cup-shaped inner recessed structure and a multiple stepped structure having the higher central column (103) and the lower multiple annular outer periphery;

FIG. 12 is a top view of FIG. 11;

As shown in FIG. 11 and FIG. 12, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other annular surface of the heat dissipater (100) is formed with two or more cup-shaped inner recessed structures and a central column (103) and two or more layers of surfaces of heat dissipater (101), thereby forming a multiple stepped structure having the higher central column (103) and the lower multiple annular outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), the inner annular heat dissipater, and the heat source zone having its bottom being installed with the electric luminous body (200) and the solid central column (103) (as shown FIG. 11 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by two or more cup-shaped inner recessed structures formed on the other surface of the heat dissipater (100), the central column (103), and two or more layers of the annular surfaces of heat dissipater (101), thereby forming a multiple stepped structure having the higher central column (103) and the lower multiple annular outer periphery; furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the inner annular heat dissipater and the heat source zone having its bottom being installed with the electric luminous body (200) and the central column (103) or the tubular central column (103) with penetrated hole, the heat in the central heat source zone can be assisted to be dissipated to the surrounding through the surface of the heat conductive rib (310) and the annular surface of heat dissipater (101);

the mentioned heat dissipater (100) further includes that the cup-shaped structure formed in the heat dissipater (100) opposite to the installation location of the electric luminous body (200) has two or more cup-shaped inner recessed structures and a central column (103) and two or more layers of annular surfaces of heat dissipater (101), thereby forming a multiple-stepped structure having the higher outer periphery.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a central column (103) and a heat conductive rib structure (310);

FIG. 14 is a top view of FIG. 13;

As shown in FIG. 13 and FIG. 14, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a central column (103), thereby forming a structure of the central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) (as shown in FIG. 13 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure having the annular structure formed with the crown-like tooth notch (105) at the upper periphery formed on the other surface of the heat dissipater (100), the central column (103), and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

FIG. 15 is a schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notches (105) and a structure having the higher central column (103) and the lower outer periphery;

FIG. 16 is a top view of FIG. 15;

As shown in FIG. 15 and FIG. 16, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notches (105) at the upper periphery and a central column (103), thereby forming a multiple annular structure having the higher central column (103) and having the lower crown-like tooth notches (105) at the outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the cup-shaped inner recessed structure of the heat dissipater (100), and the annular structure formed with the crown-like tooth notches therein, and the heat source zone having its bottom being installed with the electric luminous body (200) and the solid central column (103) (as shown in FIG. 15 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the multiple annular structure having the higher central column (103) and the lower crown-like tooth notches (105) at the outer periphery formed at the upper periphery of cup-shaped inner recessed structure at the other surface of the heat dissipater (100) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the annular structure having crown-like tooth notches therein and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101);

the mentioned heat dissipater (100) further includes that the upper periphery of the cup-shaped structure formed in the heat dissipater (100) opposite to the installation location of the electric luminous body (200) has multiple crown-like tooth notches (105) and a central column (103), thereby forming a structure having the lower central column (103) and the higher multiple annular structure having the crown-like tooth notches (105) at the outer periphery;

the multiple annular structure of the mentioned multiple crown-like tooth notches (105) is defined as two or more layers.

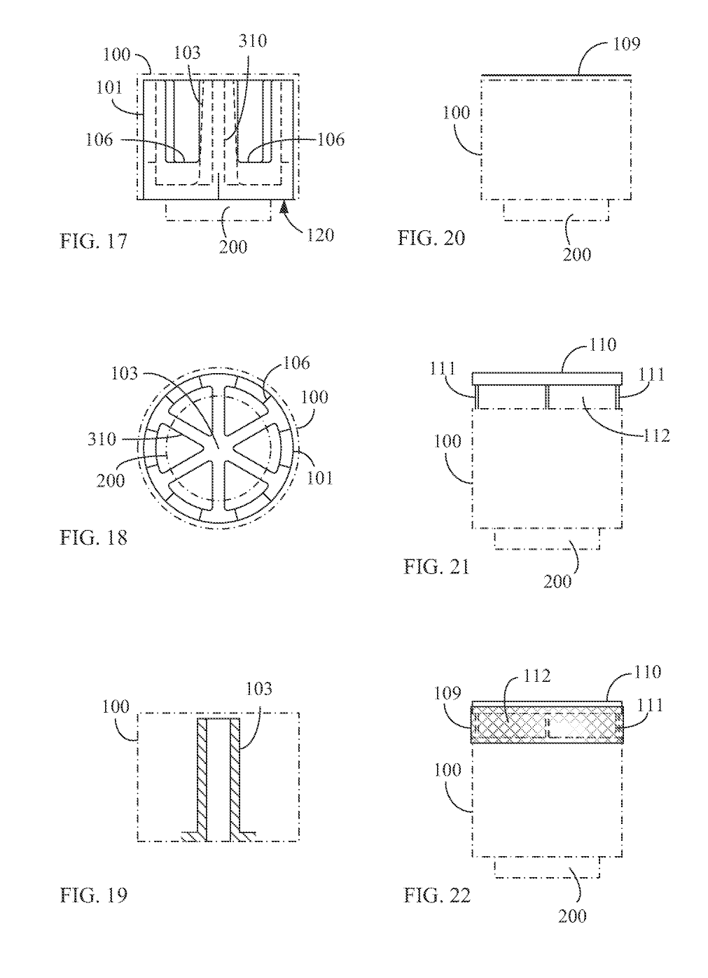

FIG. 17 is a schematic view illustrating the heat dissipater (100) opposite to the installation location of the electric luminous body (200) being installed with a conical column member and the cup-shaped structure being formed as a fork-shaped annular structure, according to the present invention;

FIG. 18 is a top view of FIG. 17;

As shown in FIG. 17 and FIG. 18, it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical central column (103); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the fork-shaped annular structure (106) of the cup-shaped inner recessed structure of the heat dissipater (100), and the heat source zone having its bottom being installed with the electric luminous body (200) and the solid central column (103) (as shown in FIG. 17 is an embodiment formed in the solid state) or the tubular central column (103) (as shown in FIG. 19) for transferring the heat;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure being formed as the fork-shaped annular structure (106) and installed with the conical central column (103) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the fork-shaped annular structure (106) of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

According to the cup-shaped heat dissipater having heat conductive rib therein and applied in electric luminous body, the central column (103) except for being composed of a solid central column, it can be further composed of a tubular central column;

FIG. 19 is a schematic structural view illustrating the central column (103) being composed as a tubular central column, according to one embodiment of the present invention;

As shown in FIG. 19, the central column (103) of the present invention is formed as a tubular structure.

FIG. 20 is a schematic lateral view illustrating the top of the heat dissipater (100) opposite to the installation location of the electric luminous body (200) being additionally installed with a protection net (109), according to one embodiment of the present invention;

As shown in FIG. 20, according to one embodiment of the present invention, the top of the heat dissipater (100) opposite to the installation location of the electric luminous body (200) is additionally installed with the protection net (109).

FIG. 21 is a schematic lateral view illustrating the top of the heat dissipater (100) opposite to the installation location of the electric luminous body (200) being installed with a top cover (110), and formed with a ventilation port (112) and a support column (111) served for connecting and supporting between the top cover (110) and the heat dissipater (100), according to one embodiment of the present invention;

As shown in FIG. 21, according to one embodiment of the present invention, the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100).

FIG. 22 is a schematic lateral view illustrating the support column (111) served for connecting and supporting being installed between the top of the heat dissipater (100) opposite to the installation location of the electric luminous body (200) and the top cover (110), and the periphery of the ventilation port (112) being additionally installed with the protection net (109), according to one embodiment of the present invention;

As shown in FIG. 22, according to one embodiment of the present invention, the support column (111) served for connecting and supporting is installed between the top of the heat dissipater (100) opposite to the installation location of the electric luminous body (200) and the top cover (110), and the periphery of the ventilation port (112) is additionally installed with the protection net (109).

The mentioned electric luminous body (200) according to the cup-shaped heat dissipater having heat conductive rib therein and applied in electric luminous body can be further configured by the electric luminous body and optical component and lampshade.

1. A cup-shaped heat dissipater having heat conductive rib therein and applied in electric luminous body, which provides a cup-shaped heat dissipater having heat conductive rib therein; the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater (100), and further with the enlarged heat dissipation surface formed in the cup-shaped inner recessed structure of the heat dissipater (100) opposite to the installation location of the electric luminous body (200), the heat can also be directly dissipated through the larger heat dissipation area; with the heat conductive rib structure (310) oppositely formed in the cup-shaped inner recessed structure of the heat dissipater (100) and combined with the inner periphery of the cup-shaped inner recessed structure of the heat dissipater (100) and the heat source zone having its bottom being installed with the electric luminous body (200), the heat in the central heat source zone can be assisted to be dissipated to the surrounding through the annular surface of heat dissipater (101); it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a multiple grid state with circular or polygonal shape having three or more sides, disposed in the cup-shaped inner recessed structure, served for connecting between the inner periphery of the cup-shaped inner recessed structure of the heat dissipater (100) and the heat source zone having its bottom being installed with the electric luminous body (200) for transferring the heat;
the outer cup bottom of the cup-shaped heat dissipater is formed as a planar or convex or concave surface for accommodating the electric luminous body (200), so the heat generated by the electric luminous body (200) can be dissipated to the exterior from the surface of the heat dissipater, and further with the enlarged heat dissipation surface formed in the cup-shaped inner recessed structure opposite to the installation location of the electric luminous body (200), the heat can also be directly dissipated through the larger heat dissipation area; moreover, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200), the heat in the central heat source zone can be assisted to be dissipated to the surrounding through the surface of the heat conductive rib (310) and the annular surface of heat dissipater (101).

2. A cup-shaped heat dissipater having heat conductive rib therein and applied in electric luminous body as claimed in claim 1, wherein the cup-shaped structure formed in the heat dissipater (100) opposite to the installation location of the electric luminous body (200) is further formed with a single annular cup-shaped inner recessed structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), the other surface of the heat dissipater (100) is formed with the single cup-shaped inner recessed structure and a central column (103); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100), the central column (103) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

3. A cup-shaped heat dissipater having heat conductive rib therein and applied in electric luminous body as claimed in claim 2, wherein the cup-shaped structure formed in the heat dissipater (100) opposite to the installation location of the electric luminous body (200) is further formed with a multiple annular cup-shaped inner recessed structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), the other surface of the heat dissipater (100) is formed with two or more cup-shaped inner recessed structures and the central column (103) and two or more layers of annular surfaces of heat dissipater (101); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the two or more cup-shaped inner recessed structures formed on the other surface of the heat dissipater (100), the central column (103) and two or more layers of annular surfaces of heat dissipater (101); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the inner annular heat dissipater and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

4. A cup-shaped heat dissipater having heat conductive rib therein and applied in electric luminous body as claimed in claim 3, wherein the cup-shaped structure formed in the heat dissipater (100) opposite to the installation location of the electric luminous body (200) is further formed with a single annular cup-shaped inner recessed structure and a stepped structure having the higher central column (103) and the lower outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single cup-shaped inner recessed structure and a higher central column (103), thereby forming a stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100), the higher central column (103) thereby forming a stepped structure having the higher central column (103) and the lower outer periphery and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

5. A cup-shaped heat dissipater having heat conductive rib therein and applied in electric luminous body as claimed in claim 2, wherein the cup-shaped structure formed in the heat dissipater (100) opposite to the installation location of the electric luminous body (200) is further formed with a single annular cup-shaped inner recessed structure and a stepped structure having the lower central column (103) and the higher outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single cup-shaped inner recessed structure and a lower central column (103), thereby forming a stepped structure having the lower central column (103) and the higher outer periphery; the surface of one or both of the cup periphery and/or the inner annular surface of the heat dissipater (100) is formed as a planar or wavelike structure or formed with a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single cup-shaped inner recessed structure formed on the other surface of the heat dissipater (100) and the lower central column (103), thereby forming a stepped structure having the lower central column (103) and the higher outer periphery and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

6. A cup-shaped heat dissipater having heat conductive rib therein and applied in electric luminous body as claimed in claim 3, wherein the cup-shaped structure formed in the heat dissipater (100) opposite to the installation location of the electric luminous body (200) is further formed with a multiple annular cup-shaped inner recessed structure and a multiple stepped structure having the higher central column (103) and the lower multiple annular outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other annular surface of the heat dissipater (100) is formed with two or more cup-shaped inner recessed structures and a central column (103) and two or more layers of surfaces of heat dissipater (101), thereby forming a multiple stepped structure having the higher central column (103) and the lower multiple annular outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100); the heat conductive rib structure (310) is formed in a strip or sheet state, disposed in the cup-shaped inner recessed structure, served for connecting between the inner periphery of the cup-shaped inner recessed structure of the heat dissipater (100), the inner annular heat dissipater, and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by two or more cup-shaped inner recessed structures formed on the other surface of the heat dissipater (100), the central column (103), and two or more layers of the annular surfaces of heat dissipater (101), thereby forming a multiple stepped structure having the higher central column (103) and the lower multiple annular outer periphery; furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the inner annular heat dissipater and the heat source zone having its bottom being installed with the electric luminous body (200) and the central column (103) or the tubular central column (103) with penetrated hole, the heat in the central heat source zone can be assisted to be dissipated to the surrounding through the surface of the heat conductive rib (310) and the annular surface of heat dissipater (101);
the mentioned heat dissipater (100) further includes that the cup-shaped structure formed in the heat dissipater (100) opposite to the installation location of the electric luminous body (200) has two or more cup-shaped inner recessed structures and a central column (103) and two or more layers of annular surfaces of heat dissipater (101), thereby forming a multiple-stepped structure having the higher outer periphery.

7. A cup-shaped heat dissipater having heat conductive rib therein and applied in electric luminous body as claimed in claim 2, wherein the upper periphery of the cup-shaped structure formed in the heat dissipater (100) opposite to the installation location of the electric luminous body (200) is further formed with a crown-like tooth notch (105) and formed with a central column (103) and a heat conductive rib structure (310), and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a central column (103), thereby forming a structure of the central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure having the annular structure formed with the crown-like tooth notch (105) at the upper periphery formed on the other surface of the heat dissipater (100), the central column (103), and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

8. A cup-shaped heat dissipater having heat conductive rib therein and applied in electric luminous body as claimed in claim 3, wherein the upper periphery of the cup-shaped structure formed in the heat dissipation member (100) opposite to the installation location of the electric-powered light emitting unit (200) is further formed with multiple crown-like tooth notches (105) and a structure having the higher central column (103) and the lower outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notches (105) at the upper periphery and a central column (103), thereby forming a multiple annular structure having the higher central column (103) and having the lower crown-like tooth notches (105) at the outer periphery; the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the cup-shaped inner recessed structure of the heat dissipater (100), and the annular structure formed with the crown-like tooth notches therein, and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the multiple annular structure having the higher central column (103) and the lower crown-like tooth notches (105) at the outer periphery formed at the upper periphery of cup-shaped inner recessed structure at the other surface of the heat dissipater (100) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the cup-shaped inner recessed structure of the heat dissipater (100), and the annular structure having crown-like tooth notches therein and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101);
the mentioned heat dissipater (100) further includes that the upper periphery of the cup-shaped structure formed in the heat dissipater (100) opposite to the installation location of the electric luminous body (200) has multiple crown-like tooth notches (105) and a central column (103), thereby forming a structure having the lower central column (103) and the higher multiple annular structure having the crown-like tooth notches (105) at the outer periphery;
the multiple annular structure of the mentioned multiple crown-like tooth notches (105) is defined as two or more layers.

9. A cup-shaped heat dissipater having heat conductive rib therein and applied in electric luminous body as claimed in claim 2, wherein the heat dissipater (100) opposite to the installation location of the electric luminous body (200) is further installed with a conical column member and the cup-shaped structure being formed as a fork-shaped annular structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical central column (103); the surface of one or both of the cup periphery and/or the inner annular surface of the heat dissipater (100) is formed as a planar or wavelike structure or formed as a structure having heat dissipation fins;
heat conductive rib structure (310): made by materials having great heat conductivity, integrally formed or assembled with the heat dissipater (100), the heat conductive rib structure (310) is formed in a strip or sheet state, disposed in the cup-shaped inner recessed structure, served for connecting between the inner periphery of the fork-shaped annular structure (106) of the cup-shaped inner recessed structure of the heat dissipater (100), and the heat source zone having its bottom being installed with the electric luminous body (200) and the solid central column (103) or the tubular central column (103) for transferring the heat;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure being formed as the fork-shaped annular structure (106) and installed with the conical central column (103) and the annular surface of heat dissipater (101) of the heat dissipater (100); furthermore, with the heat conductive rib structure (310) oppositely formed in the cup-shaped inner recessed structure of the heat dissipater (100), served for connecting between the inner periphery of the fork-shaped annular structure (106) of the cup-shaped inner recessed structure of the heat dissipater (100) and the heat source zone having its bottom being installed with the electric luminous body (200) and the solid central column (103) or the tubular central column (103) with penetrated hole, the heat in the central heat source zone can be assisted to be dissipated to the surrounding through the surface of the heat conductive rib (310) and the annular surface of heat dissipater (101).

10. A cup-shaped heat dissipater having heat conductive rib therein and applied in electric luminous body, wherein:
(a) the top of the heat dissipater (100) opposite to the installation location of the electric luminous body (200) is additionally installed with the protection net (109);
(b) the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100);
(c) both (a) and (b) are installed.
